(19) United States
(12) Patent Application Publication
(10) Pub. No.: US 2009/0135200 A1
(43) Pub. Date: May 28, 2009

(54) Selective Edge Blending Based on Displayed Content

(76) Inventor: Mark Alan Schultz, Carmel, IN (US)

Correspondence Address: Robert D. Shedd;Thomson Licensing LLC, 2 Independence Way, PRINCETON, NJ, 08543-5312, US

(21) Appl. No.: 11/922,540

(22) PCT Filed: Jun. 28, 2005
(86) PCT No.: PCT/US2005/022674

§ 371 Date: Dec. 19, 2007

(51) Int. Cl. G09G 5/00

(52) U.S. Cl. 345/629

(57) ABSTRACT

A method and an image processing system for blending edges of images for collective display. The method includes the step of evaluating at least a pair of images whose edges border each other when displayed to determine whether the collective display of images will benefit from blending of the edges (113). If so, at least portions of the edges are blended.

### FIELD OF THE INVENTION

The present invention generally relates to image processing and, more particularly, to processing segmented images for display.

### BACKGROUND OF THE INVENTION

A segmented display simultaneously presents multiple images. A segmented display can comprise a single display that presents multiple images simultaneously in different regions of the display, an array of display panels in which the display panels cooperate to present images, a projection system using a plurality of projectors to project multiple images, or any other display system which can display a plurality of images. Sometimes each of the images remains distinct from the other displayed images. Other times the adjacent images together form a larger image.

When adjacent images form a larger image, the images typically overlap to insure blank regions don't appear between the individual images. With adjacent images forming a larger image, edge blending often occurs to blend the seams of the adjacent images by evening out the brightness in the seamed area. When multiple projectors project images onto a flexible screen, however, movement of the screen can cause edges of a blended seam to become misaligned, which is undesirable. Moreover, evening of the brightness reduces contrast. When multiple images are not being used to form a single large image, but instead are providing multiple independent images, the reduction in contrast can become undesirable.

### SUMMARY OF THE INVENTION

The present invention relates to a method and an image processing system for blending edges of images for collective display. The method includes the step of evaluating at least a pair of images whose edges border each other when displayed to determine whether the collective display of images will benefit from blending of the edges. If so, at least portions of the edges undergo blending.

Another embodiment of the present invention can include a machine-readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a flowchart, which is useful for understanding the present invention.

FIG. 2 depicts a segmented display having presented thereon a group of images.

FIG. 3 depicts the segmented display having presented thereon another group of images.

FIG. 4a depicts the segmented display having presented thereon yet another group of images.

FIG. 4b depicts an exploded view of individual images presented on the segmented display of FIG. 4a.

FIG. 5 depicts a block diagram of an image processing system, which is useful for understanding the present invention.

### DETAILED DESCRIPTION

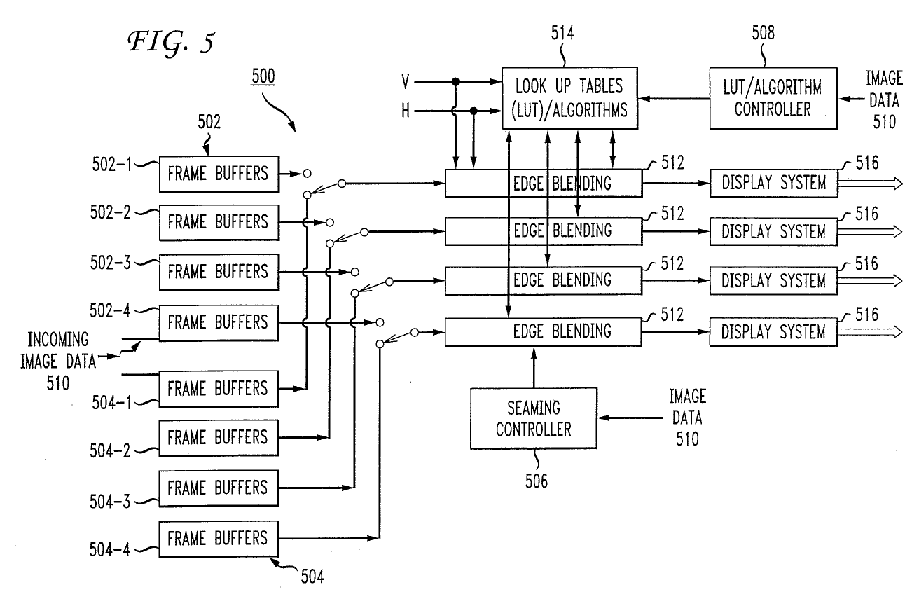

FIG. 5 depicts a block diagram of an image processing system 500 which is useful for understanding the present invention. The image processing system 500 can include frame buffers 502, 504, a seaming controller 506 and an Look-up Table (LUT)/algorithm controller 508, each of which receive image data 510. The seaming controller 506 serves to evaluate images for display in accordance the methods described herein to selectively control edge blending processors 512, which are used to selectively apply edge blending. The LUT/algorithm controller 508 evaluates images to be displayed and modifies the look up tables (LUTs) and/or select algorithms 514 which are used by the edge blending processors 512, each executing at least one edge blending process, to compute pixel values to implement edge blending. Moreover, if the seaming controller 506 instructs edge blending processors 512 to blend a portion of a particular seam, but another portion of the seam should remain unblended, the LUT/algorithm controller 508 can modify look up tables and/or algorithms used by the edge blending processors 512 so that selective blending can be applied as required. Such look up tables and algorithms are known to the skilled artisan.

A plurality of frame buffers 502, 504 serve to assemble incoming image data 510 before being processed by the seaming controller 506, LUT/Algorithm controller 508 and the edge blending processors 512. Each frame buffer 502, 504 can include a plurality of sections 502-1, 502-2, 502-3, 502-4, 504-1, 504-2, 504-3, 504-4, respectively, of frame memory. For example, a frame memory in each frame buffer 502, 504 can be allocated to a respective display system 516. The frame buffer 502 can be used to store data of a first frame, and then frame buffer 504 serves to store data of a next frame. Accordingly, while data undergoes storage in the frame buffer 504, the frame buffer 502 can be read into the blending processors 512 and forwarded to the display systems 516. In a similar manner, while data is being stored to frame buffer 502, frame buffer 504 can be read into the blending processors 512 and forwarded to the display systems 516. In one arrangement, the architecture can duplicate the seamed pixels at the input to the frame buffers 502, 504. In another arrangement, seamed pixels can be read from the frame buffers 502, 504 twice to build the edge blended seams. Nonetheless, other arrangements can be implemented and the invention is not limited in this regard.

After selectively applying edge blending, where required, the edge blending processors 512 will forward processed images to a respective portion of a display system 516 for presentation. The display system 516 can comprise a segmented display having a single display in which multiple images are simultaneously presented in different regions of the display, an array of display panels in which the display panels cooperate to present images, a projection system using a plurality of projectors to project multiple images, or any other display system which can display a plurality of images.

The image processing system of FIG. 5 can be realized in hardware, software, or a combination of hardware and software. The image processing system can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a computer system with a computer program that, when being loaded and executed, controls the computer system such that it carries out the methods described herein.

The present invention also can be embedded in a computer program product, which comprises all the features enabling the implementation of the methods described herein, and which when loaded in a processing system is able to carry out these methods. Computer program, software, or software application, in the present context, means any expression, in any language, code or notation, of a set of instructions intended to cause a system having an information processing capability to perform a particular function either directly or after either or both of the following: a) conversion to another language, code or notation; b) reproduction in a different material form.

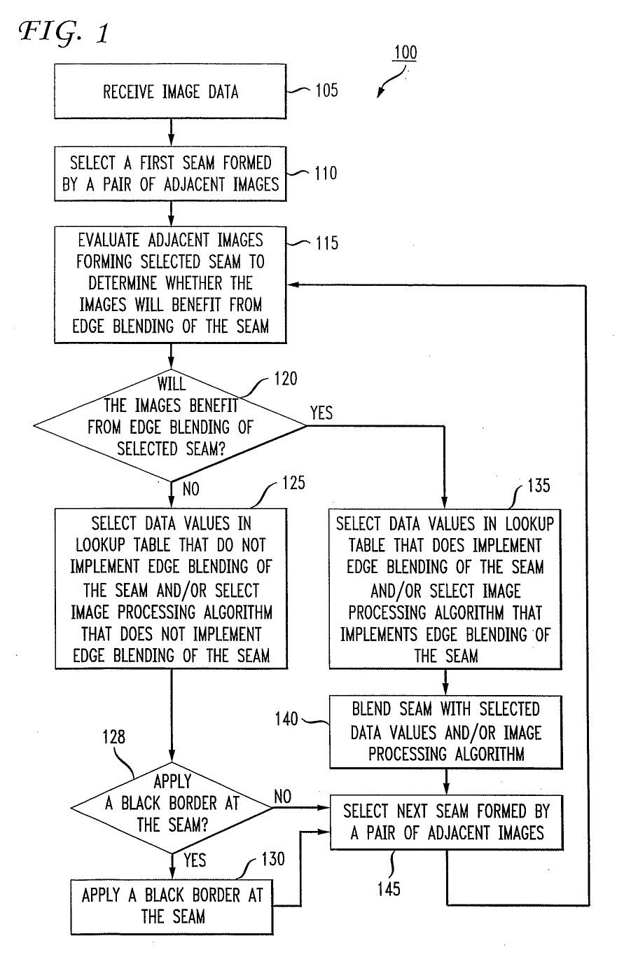

FIG. 1 depicts a flowchart, which is useful for understanding a method 100 capable of being practiced by the apparatus of FIG. 5 for implementing the present invention. Step 105 commences with the receipt of image data for images for presentation by the segmented display system of FIG. 5. During step 110 of FIG. 1, selection of a first seam, formed by a pair of adjacent images, occurs. Proceeding to step 115, the adjacent images undergo evaluation to determine whether the images will benefit from edge blending of the selected seam. For instance, data representing positioning of the images in a presentation and whether the images cooperate to form a larger image undergo processing by the image processing system of FIG. 5 as discussed previously. In addition, the type of display that is used to present the images can be considered as part of the evaluation process. The display type can be received as a user selectable input entered into the image processing system.

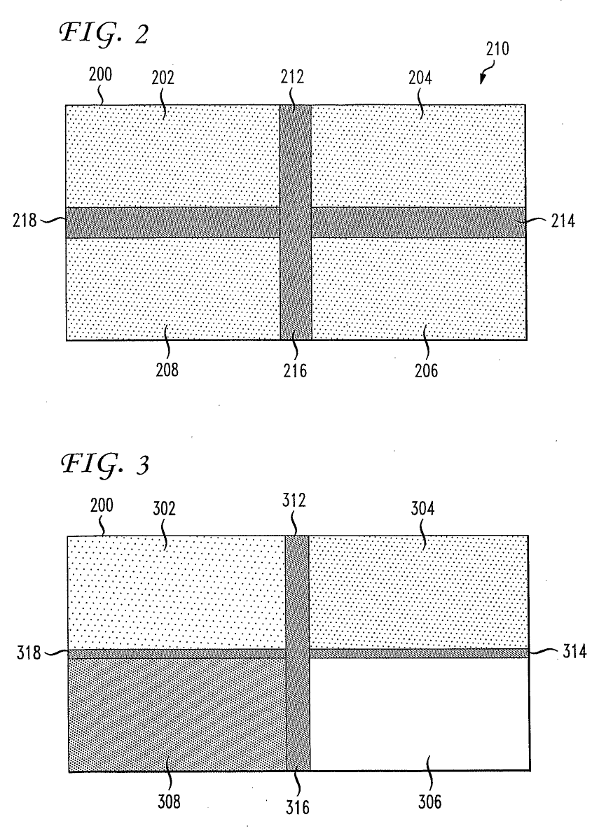

FIG. 2 depicts a segmented display 200 useful for understanding the present invention. The display 200 of FIG. 2 includes a first group of images 202, 204, 206, 208 for presentation. In this example, the images 202, 204, 206, 208 cooperate to form a larger image 210. Seams 212, 214, 216, 218 form at the boundaries of adjacent ones of the images 202, 204, 206, 208, respectively. To maximize image quality of the larger image 210, adjacent ones of the images 202, 204, 206, 208 should blend smoothly together. Accordingly the seams 212, 214, 216, 218 can benefit from edge blending, for example if the display 200 does not undergo significant movement. Nonetheless, if the display 200 comprises a flexible display, such as projection screen, the images likely will not benefit from edge blending since movement of the screen can cause misalignment of the images.

Referring to FIG. 3, the display 200 presents a second group of images 302, 304, 306, 308. In contrast to the first group of images 202, 204, 206, 208 of FIG. 2, the second group of images 302, 304, 306, 308 of FIG. 3 do not cooperate to form a single larger image, but instead each presents a self-contained image. In this instance smooth blending of the images 302, 304, 306, 308 generally will not prove desirable. Accordingly, the seams 312, 314, 316, 318 will not benefit from edge blending.

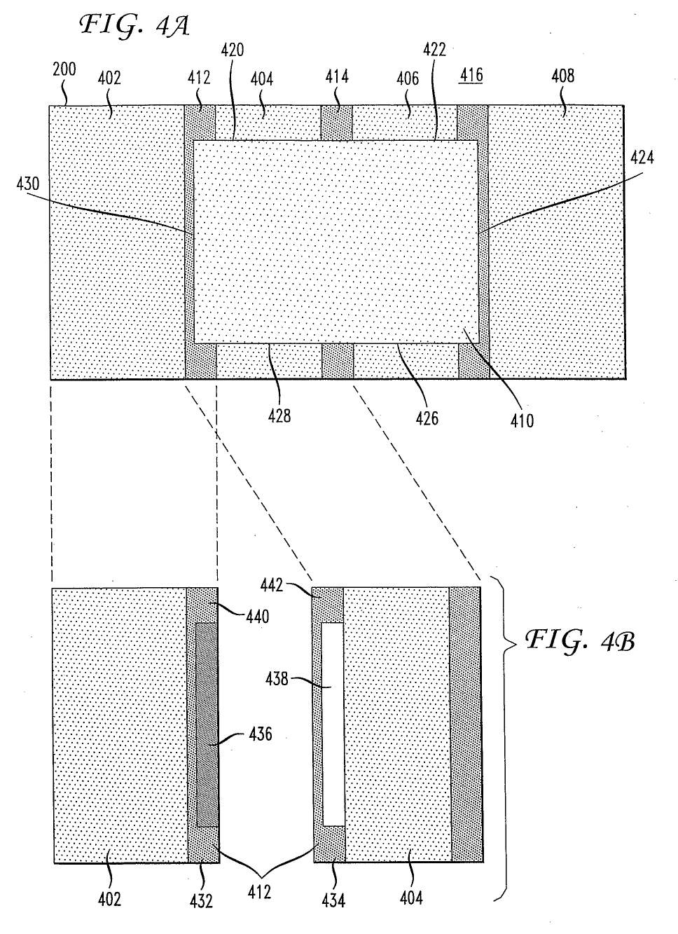

Referring to FIG. 4a, the display 200 presents a third group of images 402, 404, 406, 408, 410 for display. In this example, images 402, 404, 406, 408 cooperate to form a single larger image, while a self-contained image 410 overlays images 402, 404, 406, 408. Implementation of priority overlays exists in the art. In this instance smoothly blending the images 402, 404, 406, 408 will prove desirable, while image 410 will not undergo blending with the other images 402, 404, 406, 408. Accordingly, seams 412, 414, 416 will benefit from edge blending, while seams 420, 422, 424, 426, 428, 430 will not benefit from edge blending.

Referring to decision box 120 of FIG. 1, if the images will not benefit from edge blending of the selected seam, data values which do not implement edge blending of the selected seam are selected, and/or an image-processing algorithm that does not implement edge blending of the selected seam can be selected, as shown in step 125.

Proceeding to decision box 128 of FIG. 1, a decision occurs whether to apply a black border at the selected seam. For example, if the adjacent images are significantly different or starkly contrast, a black border generally will prove desirable. At step 130, the black border can be applied at the selected seam to separate the adjacent images forming the seam. The black border can be generated by elevation of black levels. Such black levels are known to the skilled artisan. When a flexible screen serves to display the images, the placement of black borders around the images can minimize perception of distortion caused by movement of the images relative to one another caused by screen movement. If a decision is made not to apply the black border, step 130 can be skipped.

At step 135, if the adjacent images will benefit from edge blending of the selected seam, data values which implement edge blending of the selected seam can be selected, and/or an image-processing algorithm that implements edge blending of the selected seam can be selected. The seam then can be blended in accordance with the data values and/or image-processing algorithm, as shown in step 140. At step 145, a next seam formed by a pair of adjacent images can be selected and the process can repeat until all seams to be displayed are evaluated.

Briefly referring again to FIG. 4b, an exploded view of images 402, 404 appears. The images 402, 404 each include a region 432, 434, respectively, which overlap at seam 412. Figuratively speaking, portions 436, 438 of the respective regions 432, 434 lie beneath, image 410, which constitutes an overlay image. Accordingly, seaming and blending need not occur in portions 436, 438 since they will not appear visible. Notably, edge blending of a seam can occur on a pixel-by-pixel basis so that certain portions 440, 442 of the respective regions 432, 434 undergo edge blending while portions 436, 438 do not.

Further, in an arrangement in which a first projector projects image 402 and a second projector projects image 404, pixels in portion 436 of image 402 can be set to zero so that the first projector projects minimum light for portion 436. Accordingly, a portion of image 410 that lies over the seam 412 will undergo projection exclusively by a single projector, namely the second projector. This arrangement can be implemented to maximize the quality of image 410.

The present invention relates to a method and a system for selectively implementing edge blending of adjacent images in a segmented display system. More particularly, the present invention implements edge blending on adjacent images exclusively when such edge blending will improve the appearance of images being displayed, while not blending adjacent images when such images will not benefit from edge blending. For example, edge blending can be turned off when smaller images being displayed do not cooperate to form a larger image, but instead present separate distinct images on a display. Edge blending also can be turned off when multiple projectors are used to project adjacent images onto a flexible screen that is subject to movement. When edge blending is not implemented, black borders can be placed around the images. Advantageously, placing black borders around the images can minimize perception of the movement of images relative to one another when movement of the screen occurs.

While the foregoing is directed to the preferred embodiment of the present invention, other and further embodiments of the invention may be devised without departing from the basic scope thereof. Further, ordinal references in the specification are provided to describe distinct features of the invention, but such ordinal references do not limit the scope of the present invention. Accordingly, the scope of the present invention is determined by the claims that follow.

1. A method for blending edges of images for collective display, comprising the steps of:
evaluating at least a pair of images whose edges border each other when displayed to determine whether the collective display of the at least pair of images will benefit from blending of the edges; and if so;
blending at least first portions of the edges of the at least pair of images.

2. The method according to claim 1, wherein said blending step further comprises the step of changing data values in a look-up-table.

3. The method according to claim 1, wherein said blending step further comprises the step of selecting at least one blending algorithm optimal for blending the edges, and the blending of the edges is performed in accordance with the selected at least one blending algorithm.

4. The method according to claim 1, wherein the first portions of the edges are blended, and at least second portions of the edges are not blended.

5. The method according to claim 1, wherein the edges are not blended if the collective display of the at least pair of images will not benefit from blending.

6. The method according to claim 5, further comprising the step of changing data values in a look-up-table to prevent blending of the edges.

7. The method according to claim 5, further comprising the step of selecting at least one display algorithm optimal for presenting the edges as unblended, wherein the edges are presented in accordance with the selected at least one display algorithm.

8. A machine readable storage, having stored thereon a computer program having a plurality of code sections executable by a machine for causing the machine to selectively implement edge blending by performing the steps of:
evaluating at least a pair of images whose edges border each other when displayed to determine whether the collective display of the at least pair of images will benefit from blending of the edges; and if so;
blending at least first portions of the edges of the at least pair of images.

9. The machine readable storage of claim 8, wherein said blending step comprises the step of changing data values in a look-up-table.

10. The machine readable storage of claim 8, wherein said blending step comprises the step of selecting at least one blending algorithm optimal for blending the edges, and the blending of the edges is performed in accordance with the selected at least one blending algorithm.

11. The machine readable storage of claim 8, wherein the first portions of the edges are blended, and at least second portions of the edges are not blended.

12. The machine readable storage of claim 8, Wherein the edges are not blended if the collective display of the at least pair of images will not benefit from blending.

13. The machine readable storage of claim 12, further causing the machine to perform the step of changing data values in a look-up-table to prevent blending of the edges.

14. The machine readable storage of claim 12, further causing the machine to perform the step of selecting at least one display algorithm optimal for presenting the edges as unblended, wherein the edges are presented in accordance with the selected at least one display algorithm.

15. Apparatus for displaying images comprising:
means for receiving images for display;
means for evaluating at least a pair of images whose edges border each other when displayed to determine whether the collective display of the at least pair of images will benefit from blending of the edges; and;
means for blending at least first portions of the edges of the at least pair of images when the at least pair of will benefit from blending of the edges.

16. The apparatus according to claim 15 wherein the evaluating means further comprises a look-up table and algorithm controller.

17. The apparatus according to claim 15 wherein the blending means further comprises at least one edge blending processor which executes at least one edge blending process in response to data from the evaluating means to carry out edge blending.
